(19) United States
(12) Patent Application Publication
(10) Pub. No.: US 2014/0117129 A1
(43) Pub. Date: May 1, 2014

(54) Rock Breaker

(71) Applicant: Michael James Armstrong, Lake Clifton (AU)

(72) Inventor: Michael James Armstrong, Lake Clifton (AU)

(21) Appl. No.: 13/777,195

(22) Filed: Feb. 26, 2013

(30) Foreign Application Priority Data
Nov. 1, 2012 (AU) 2012101621
Feb. 20, 2013 (AU) 2013200953

(51) Int. Cl. B02C 13/284; B02C 13/28

(52) U.S. Cl. CPC B02C 13/284; B02C 13/2804
USPC 241/73

(57) ABSTRACT

In one preferred form of the present invention, there is provided a rock breaker 10. The rock breaker 10 includes a body 12 having a recess 14 for receiving an impactor 16 that is adapted to rotate about an axis 18 extending longitudinally into the recess 14. The recess 14 includes a curved wall 20 extending along the recess 14. The curved wall 20 has a number of narrow elongate slit-type openings 22 each extending around the recess 14 across the curved wall 20. The slit-type openings 22 are spaced apart in a direction along the body 12 to form a series 68. The impactor 16 includes two impactor bars 28 that are each positioned in an offset position for rotating in a direction along the slit type openings 22, in a direction around the recess 14, with each impactor bar 28 extending across the slit type openings 22 in an adjacent manner.

### FIELD OF THE INVENTION

The present invention relates to rock breakers. In preferred embodiments, the present invention relates to rock breakers for gold prospecting.

### BACKGROUND TO THE INVENTION

Various rock breakers are used by prospectors when prospecting for gold. These rock breakers extend from simple implements to mechanical devices.

It would be advantageous to provide an improved rock breaking device for such purposes, or to at least provide the public with a useful choice.

### SUMMARY OF THE INVENTION

According to a first aspect of preferred embodiments herein described there is provided a rock breaker comprising: a body having a recess for receiving an impactor that is adapted to rotate about an axis extending longitudinally into the recess; the recess including a curved wall extending along the recess; the curved wall having a number of narrow elongate slit-type openings each extending around the recess across the curved wall; the slit-type openings being spaced apart in a direction along the body to form a series; the impactor including at least one impactor bar that is positioned in an offset position for rotating in a direction along the slit-type openings, in a direction around the recess, with the or each impactor bar extending across the slit-type openings in an adjacent manner.

Preferably the recess is a cylindrical recess and the at least one impactor bar comprises two elongate impactor bars spaced apart to fit within the cylindrical recess.

Preferably the slit-type openings comprise thin cuts made by cutting and removing material from the body.

Preferably the recess is cylindrical and defines a longitudinal axis, the rocker breaker including a hopper having a hopper opening extending through an upper wall of the recess for receiving rock before crushing, wherein the hopper opening is offset from the vertical plane containing the longitudinal axis, the vertical plane being vertical when the rock breaker is in use.

Preferably the hopper opening is provided on one side of the vertical plane containing the longitudinal axis.

Preferably the hopper opening is provided adjacent the vertical plane containing the longitudinal axis.

Preferably the recess includes a hopper having a hopper opening extending through the recess, the hopper opening being positioned such that rotational movement of the at least one impactor bar assists with urging material leaving the hopper in a downward direction by virtue of the impactor moving downwardly in the region below the hopper opening.

Preferably the recess is cylindrical and defines the longitudinal axis as the central axis, the curved wall being disposed either side of the vertical plane containing the central axis.

Preferably slits are relatively evenly spaced either side of the vertical plane containing the longitudinal axis.

Preferably the curved wall having the narrow elongate slit-type openings is provided by a wall member that is moveable between an operational position for rock crushing and an open position allowing ready access to the recess for maintenance purposes.

Preferably the wall member is hingedly connected so as to be able to be pivoted from the operational position to the open position to allow ready access to the recess for maintenance purposes.

Preferably the rock breaker includes a securing system for securing the wall member in the operational position during use of the rock breaker.

According to a second aspect of preferred embodiments herein described there is provided a rock breaker comprising: a body providing a cylindrical recess for receiving rock; an impactor for rotating about the longitudinal axis of the recess; a plurality of narrow elongate slit-type openings each extending around the recess; the slit type openings being spaced apart in a direction along the body to form a series; the impactor including at least one impactor bar that is positioned in an offset position for rotating in a direction along the slits, in a direction around the recess, with the or each impactor bar extending across the slits in an adjacent manner.

Preferably the series of narrow elongate slit-type openings comprise thin cuts arranged in series along bottom of the body of the rock breaker.

Preferably the thin cuts each extend substantially perpendicular to the length of the recess.

It is to be recognised that other aspects, preferred forms and advantages of the present invention will be apparent from the present specification including the detailed description, drawings and claims.

### BRIEF DESCRIPTION OF DRAWINGS

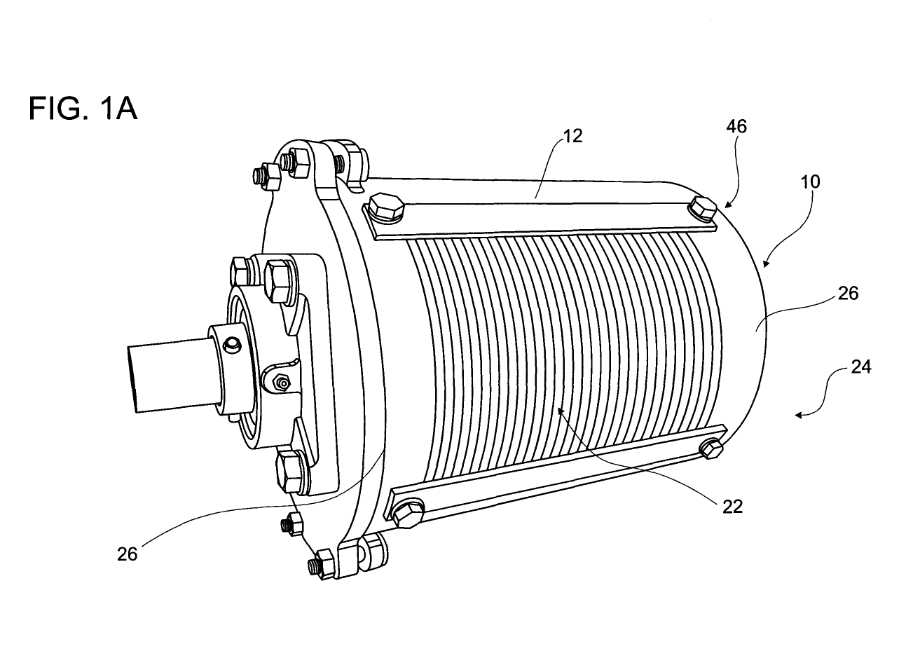

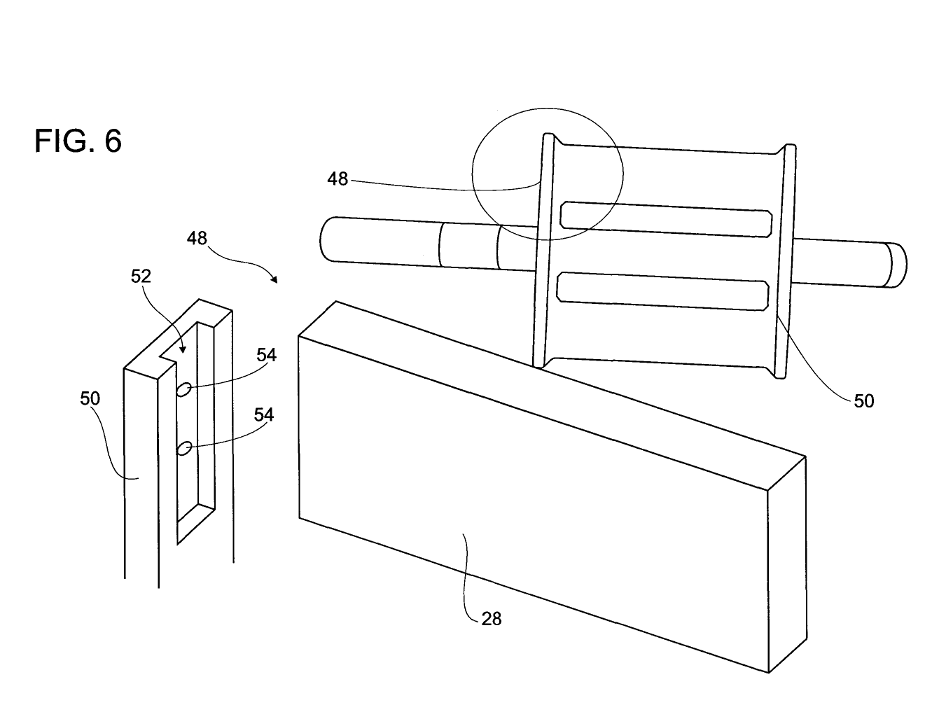

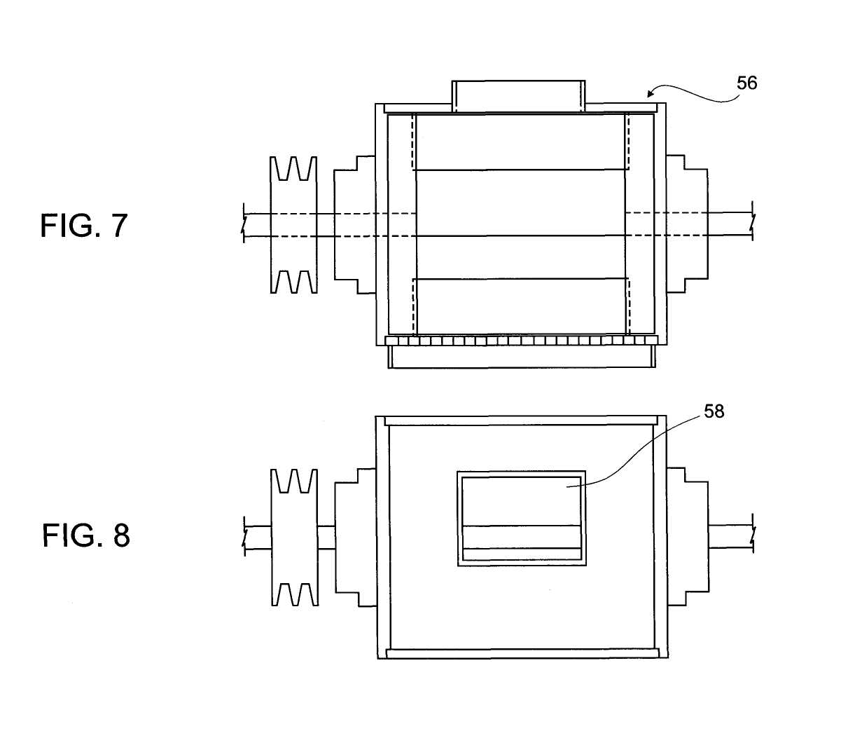

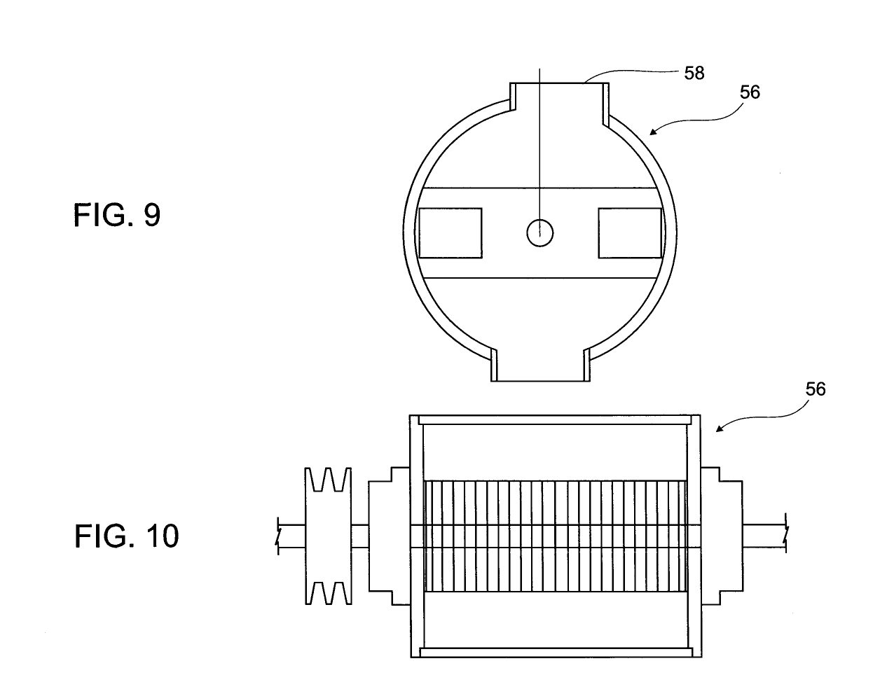

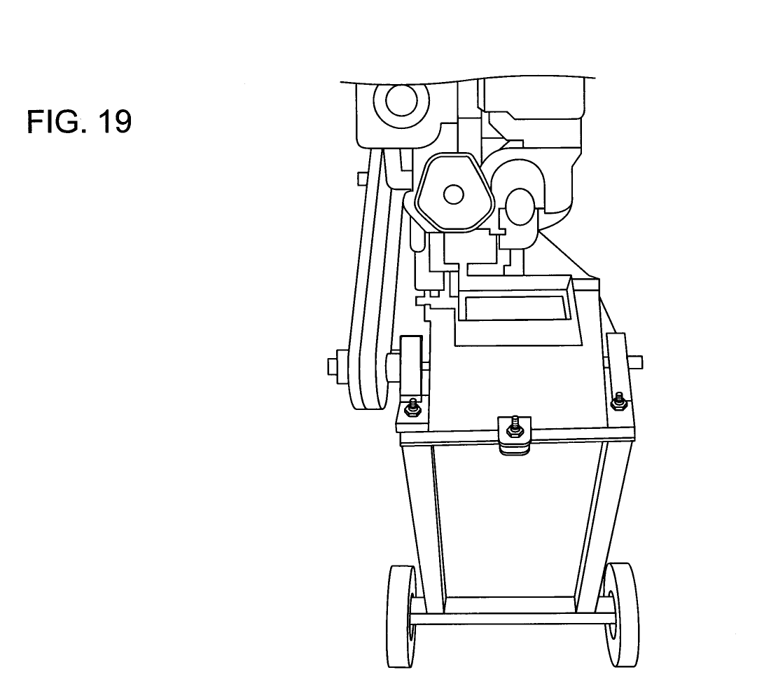

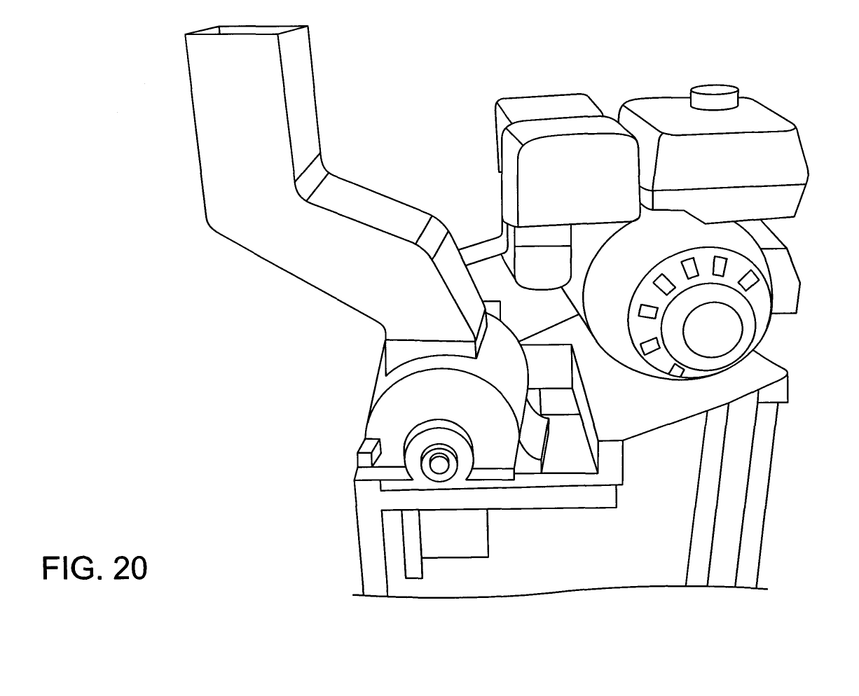

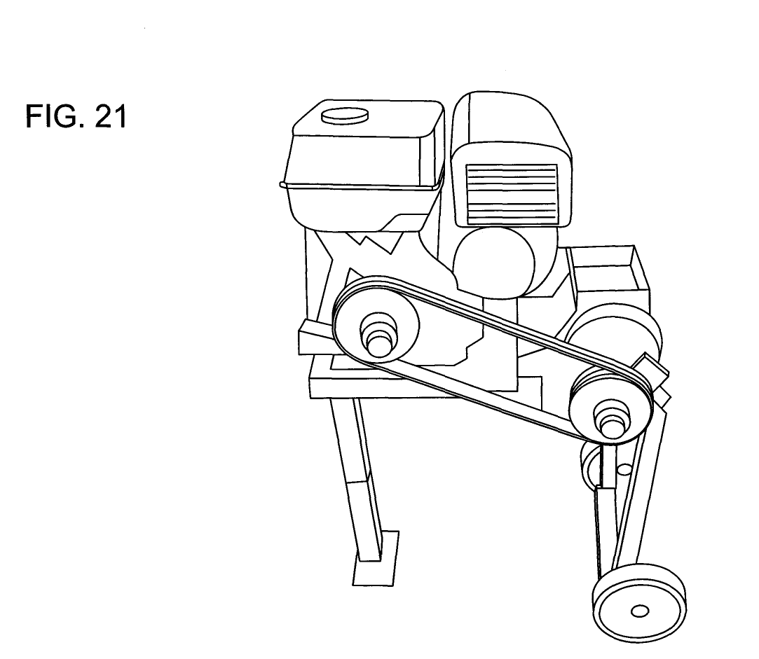

In order to facilitate a better understanding of the present invention, several preferred embodiments will now be described with reference to the accompanying drawings, comprising FIGS. 1 to 21.

### DETAILED DESCRIPTION OF THE EMBODIMENTS

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

Referring to FIGS. 1 to 3 there is shown a rock breaker 10 according to a fist preferred embodiment of the present invention. The rock breaker 10 includes a body 12 having a having a recess 14 for receiving an impactor 16. The impactor 16 is adapted to rotate at high speed about an axis 18 extending longitudinally into the recess 14. The recess 14 is cylindrical and the axis 18 is a central axis.

As shown, the recess 14 includes a cylindrically curved wall 20 that extends along the recess 14. The curved wall 20 includes a number of narrow elongate slit-type openings 22 that extend around the recess 14 across the curved wall 20. In this embodiment the slit-type openings 22 are about 1 mm in thickness. In a number of other embodiments the slit type openings 22 are less than 3 mm in thickness.

The slit type openings 22 are spaced apart in a direction along the body 12 to form a series 24 (along the longitudinal axis). The series 24 extends along a substantial length of the recess 14. The series 24, in the embodiment, extends between two end walls 26.

The slit type openings 22 are spaced about 1 cm apart. In other embodiments the slit type openings 22 are preferably spaced less than 2 cm apart. The relatively close spacing of the slit-type openings 22 and the thinness of the slits-type openings 22 is considered to assist with the breaking of gold bearing rock using the rock crusher 10.

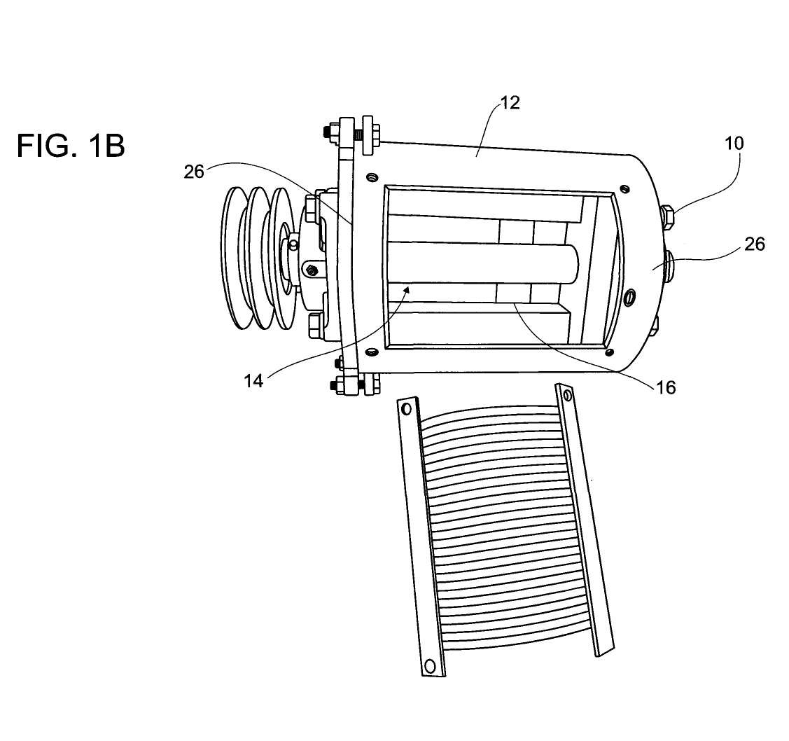

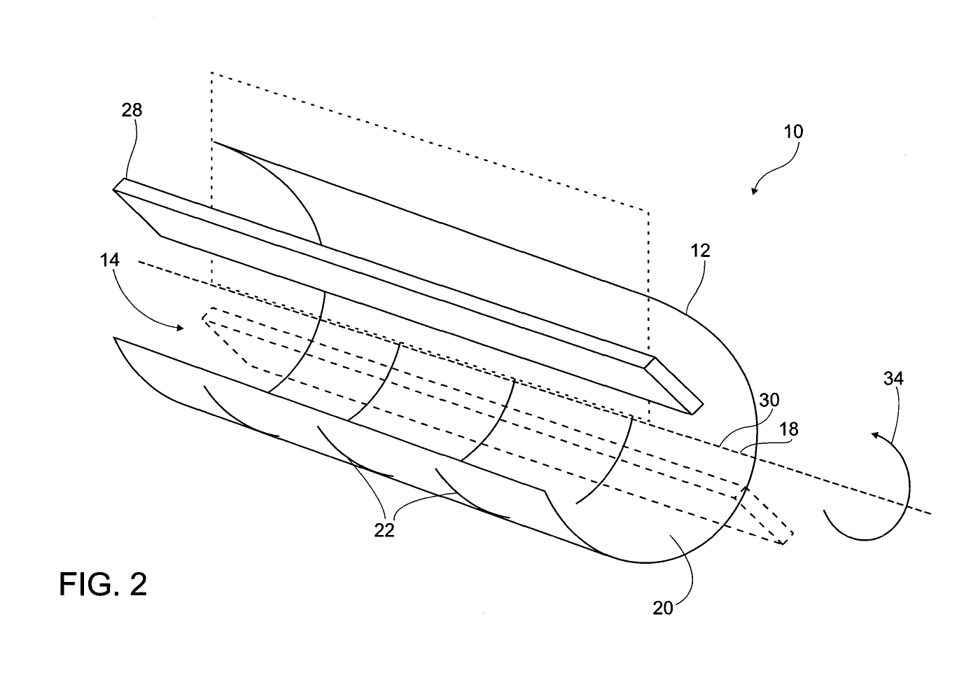

Referring to FIGS. 2 and 3, the impactor 16 includes two impactor bars 28 that are each positioned in an offset position. The impactor bars 28 are offset from the longitudinal axis 30 of the impactor 16. As shown, the impactor 16 includes a central shaft 32 that is adapted to be positioned within the recess 14 such that the longitudinal axis 18 of the recess 14 corresponds with the longitudinal axis 30 of the central shaft 32.

The two impactor bars 28 are offset from the shaft 32 for rotating about the central axis 18. In this manner, with the longitudinal axis 30 extending in the direction of the axis 18 (in a co-linear manner), the impactor bars 28 are positioned for rotating in a direction 34 along the slits 22.

Thus the impactor bars 28 are adapted to rotate in a direction around the recess 14. As shown each impactor bar 28, when above the slits 22, extends across the slits 22 in an adjacent manner.

There is accordingly provided a cylindrical recess 14 and having two elongate impactor bars 28 spaced apart to fit within the recess 14. The slit-type openings 22 comprise thin cuts made by cutting and removing material from the body 12. In this case an angle grinder disc is used to cut through a solid steel body 12 to form the slits.

The impactor 16 has a central shaft 32 that is aligned with and rotates about the longitudinal axis 18 of the recess 14.

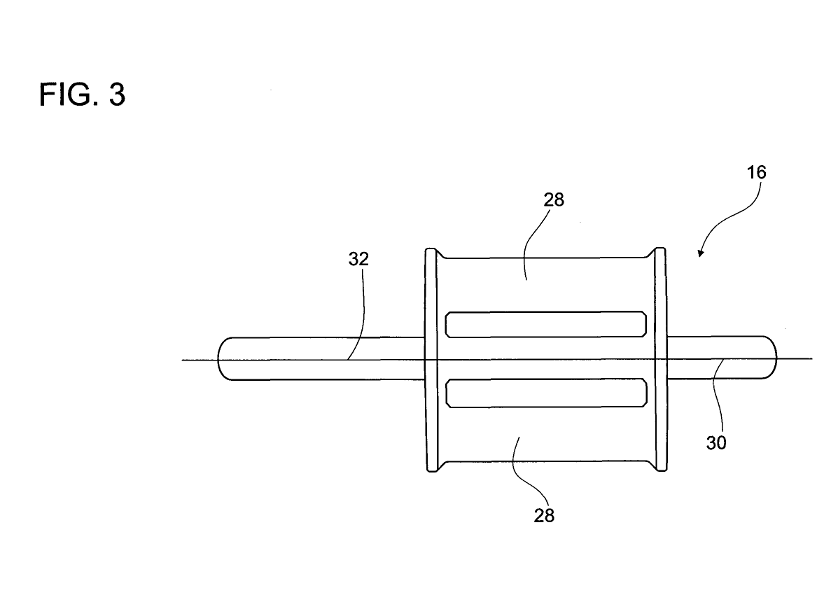

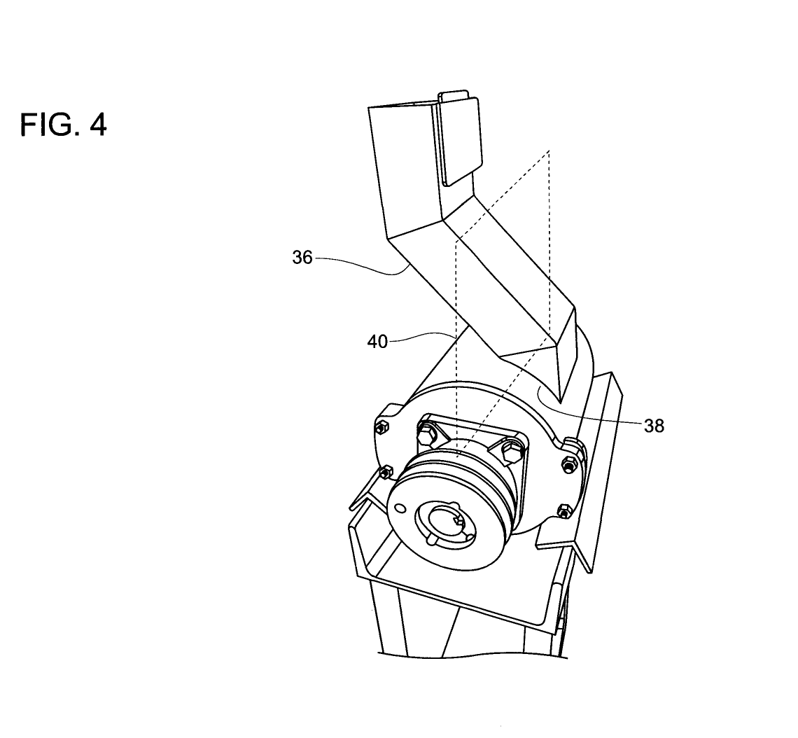

Referring to FIG. 4, the rocker breaker 10 includes a hopper 36 having a hopper opening 38 . The hopper opening 38 extends through the upper wall of the recess 14 and is offset relative to the vertical plane 40 containing the longitudinal axis 18. This is further illustrated in FIGS. 5a and 5b.

As shown in FIGS. 5a and 5b, the hopper opening 38 is provided on one side of and adjacent to the vertical plane 40. The hopper opening 38 is positioned such that rotational movement of the impactor 16 assists with urging material leaving the hopper in a downward direction 42 by virtue of the impactor bars 28 moving downwardly when in the region below the hopper opening 38.

The cylindrical lower wall 20 is disposed either side of the vertical plane 40 containing the axis 18. The slit-type openings 22 are symmetrically disposed about the vertical plane 40.

The cylindrical wall 20 is provided by a wall member 44. The wall member 44 is moveable between an operational position for rock crushing and an open position allowing ready access to the recess 14 to clear a blockage or other maintenance purposes. The operational position is shown in FIG. 5a and the open position is shown in FIG. 5b.

Returning to FIG. 1, the wall member 44 is secured in position using a bolt arrangement 46. In the bolt arrangement 46 four bolts screw into female fasteners provided in the body 12. In another embodiment the wall member 44 is hingedly connected so as to be able to be pivoted from an operational position to an open position to allow ready access to the recess 14 to clear a blockage and for maintenance purposes.

Thus there is provided a rock breaker 10 comprising a body 12 providing a cylindrical recess 14 for receiving rock. The impactor 16 is provided for rotating about the longitudinal axis 18 of the cylindrical recess 14. A plurality of narrow elongate slit-type openings 22 each extend around the recess 14. The slit-type openings 22 are spaced apart in a direction along the body 12 to form a series 24. The impactor 16 includes two impactor bar 28 that are each positioned in an offset position for rotating in a direction along the slit type openings 22 (around the recess 14). During use, each impactor bar 28 extends across the slit type openings 22 in an adjacent manner.

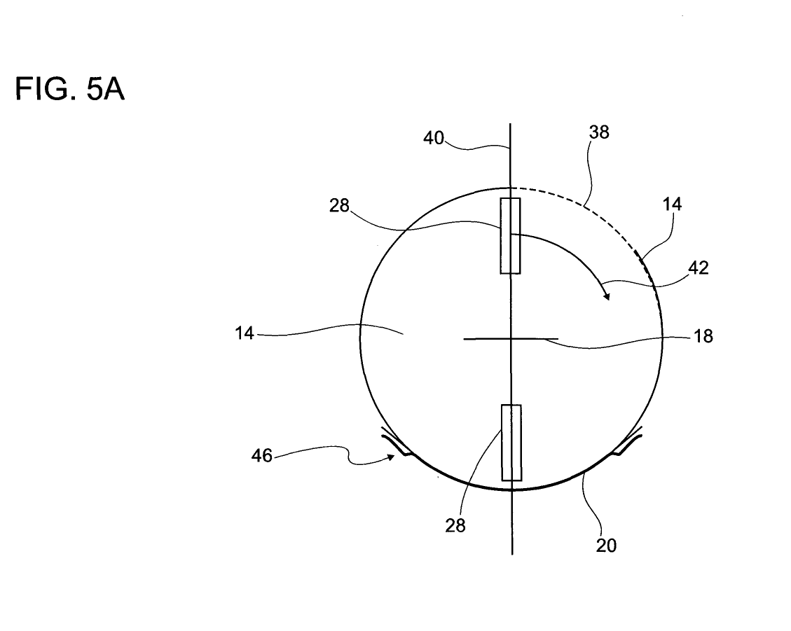

FIG. 6 illustrates a portion 48 of the impactor 16. The portion 48 includes slot system allowing each impactor bar 28 to be removed from the impactor 16 for servicing or replacement. Each impactor bar 28 is releasably secured to a flange 50 of the impactor 16. In total there are four flanges 50 (two pairs of flange arms) that extend from the central shaft 32.

The flanges 50 each include a slot 52 into which a respective impactor bar is fitted. A number of holes 54 are provided as shown for receiving screws to fix the impactor bars 28 in place. The impactor 16 accordingly includes replaceable impactor bars 28.

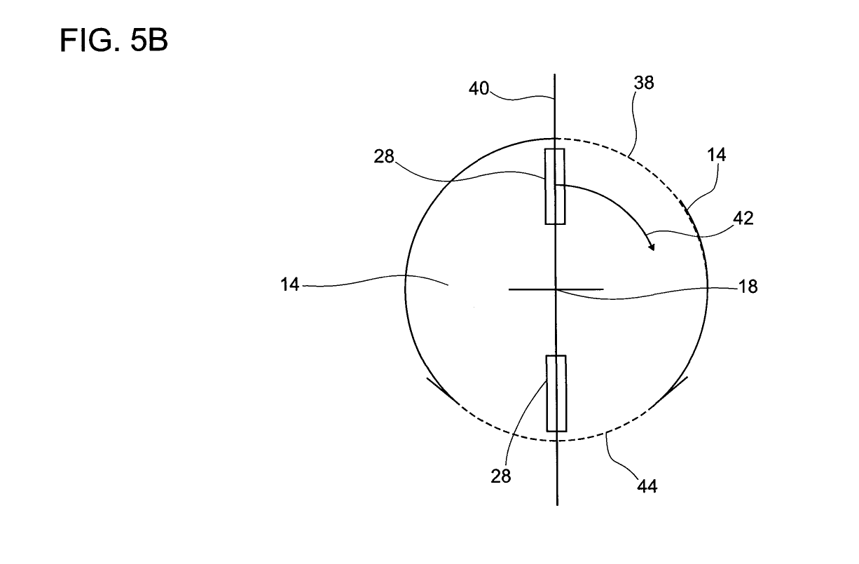

FIGS. 7 to 10 illustrate a further rock breaker 56 according to a further preferred embodiment. The degree of offsetting of the hopper opening 58 while present does not provide the hopper opening 58 only on one side of the vertical central plane. Such an arrangement is not presently preferred.

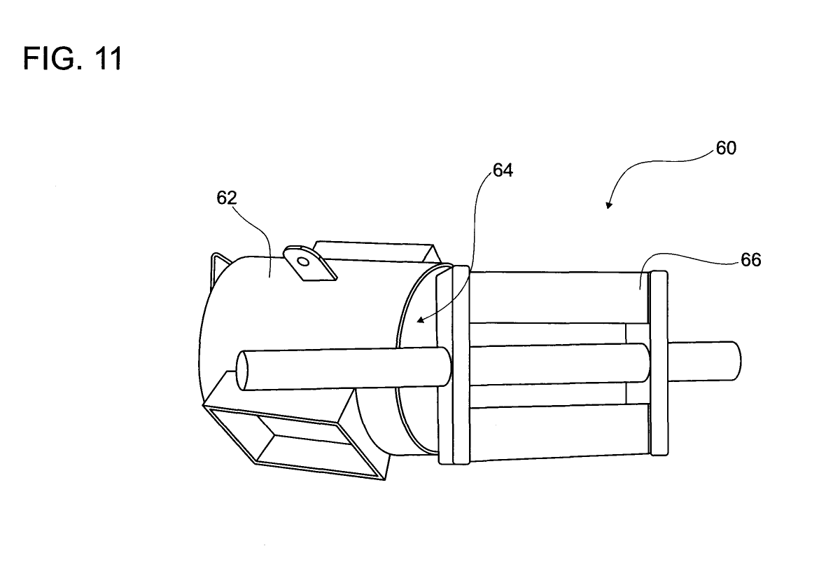

Referring to FIGS. 11 to 15 there is shown a rock breaker 60 according to a preferred embodiment of the present invention. The rock breaker 60 comprises a body 62 for providing a recess 64 for receiving rock. The rock breaker 60 further includes an impactor 66 for rotating at high speed within the recess 64.

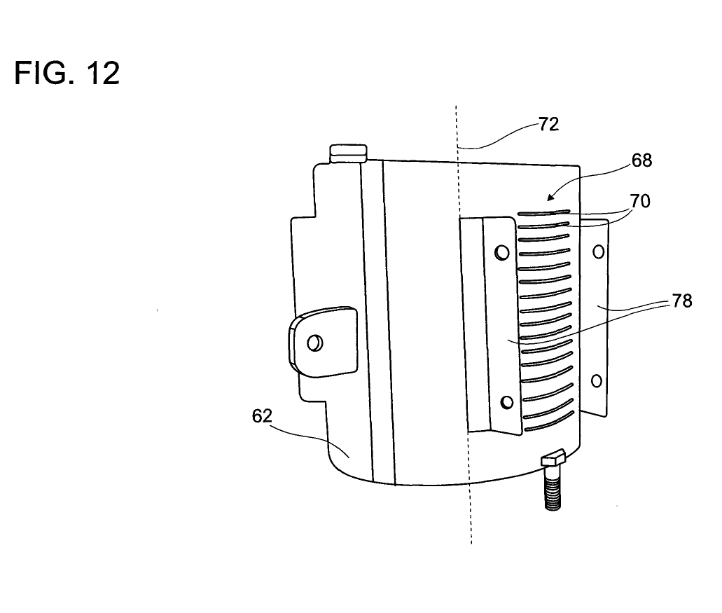

Referring to FIG. 12, the body 62 includes a series 68 of narrow elongate slit-type openings 70. The slit-type openings 70 are formed in the body 62 of the rock breaker 60. The series 68 extends with a regular spacing in the direction the longitudinal axis 72 of the body 62. There series 68 runs nearly the full length of the body 62.

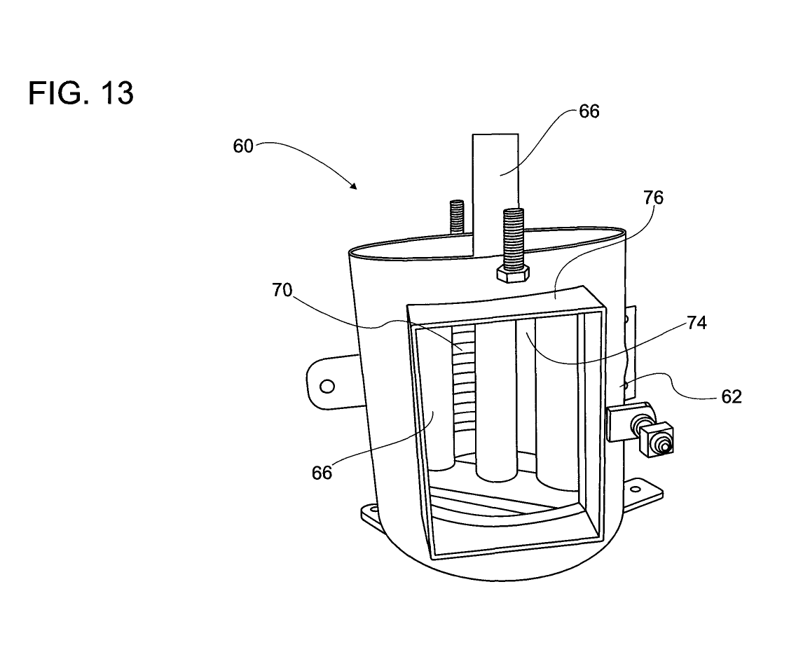

Referring to FIG. 13 the shape of the impactor 66 is able to relatively neatly fit within the cylindrical wall 74 of the recess 62.

The slit-type openings 70 are positioned so as to be adjacent the impactor 66 when the impactor 66 rotates within the recess, as shown in the drawings. The slit type openings are provided by the wall 74 itself.

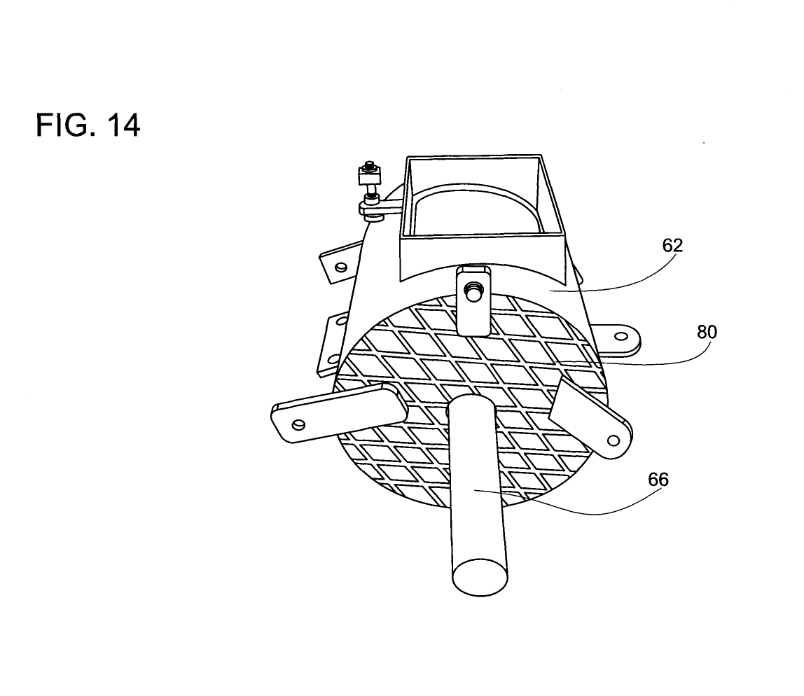

Referring to FIGS. 13 and 14, the body 62 includes a rock feed hopper portion 76 for a rock feed hopper. The rock feed hopper portion 76 is upwardly disposed and the slit-type openings 70 comprise thin cuts arranged in the series 68 along bottom of the body 62.

Referring to FIG. 12, the thin cuts each extend substantially perpendicular to the length/longitudinal axis 72 of the body/recess. A mount 78 is provided either side of the extension of the slit-type openings 70 across the body 62. The mount is provided for connection to a chute to collect the rock passing through the slit-type openings 70.

Referring the FIG. 14, the body 62 includes a closure 80 that is removable to allow separation of the impactor 66 from the body 62.

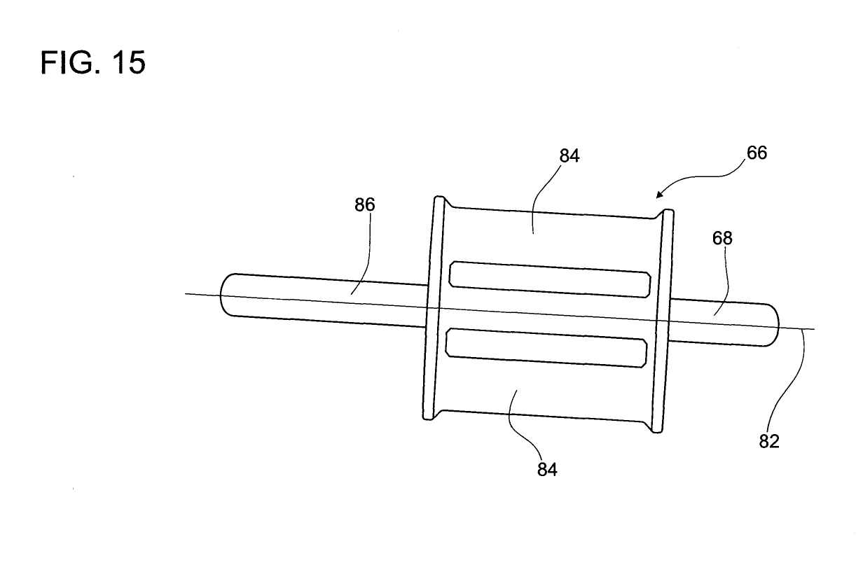

Referring to FIG. 15, the impactor 66 includes a central axis 82 and a number of impactor bars 84 arranged around the central axis. The impactor bars 84 are positioned substantially parallel to the central axis 82 and are rotated by rotating a shaft 86 defining the central axis 82.

The rock breaker provides a breaker for breaking up gold bearing rock into powder fitting through the slit type openings 70.

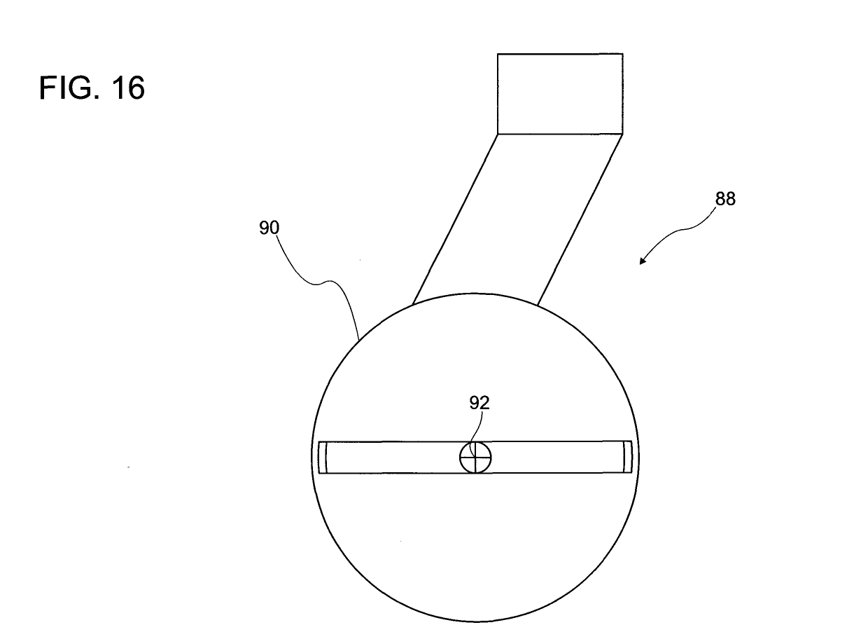

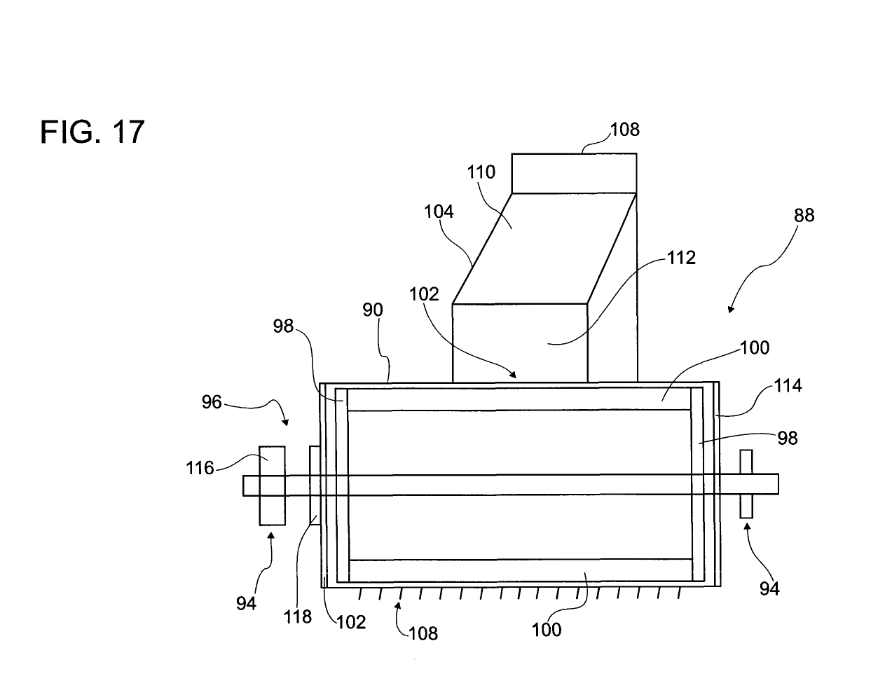

A further preferred embodiment of the present invention is shown in FIGS. 16 and 17. The embodiment comprises a Gold Rock Breaker Cylinder 88 for processing gold bearing rock. A cylinder 90 is provided comprising a round steel tube. Through the middle of the steel cylinder goes a shaft 92 which is attached to a bearing and bearing and bearing housing 94 at each end (see FIG. 17).

At each end of the steel cylinder 90 are steel flanges 96 each with a hole in the centre for the shaft 92 to go through. One end is welded, the other end is bolted so the shaft 92 can slide in and out.

On the shaft 92 at each end of the shaft 92 inside the cylinder 90 is a flat steel bar 98 with a hole in each one, so the shaft slides through the middle of these. The flat bar length is nearly the length of the cylinder diameter which gives clearance when rotating. The flat bars are welded to the shaft 92. Welded to theses bars are two more bars 100 of hardened steel, these are the impacter bars. These bars are now welded length ways to the other bars, and will rotate in the cylinder at high speed to break up the rock.

On top of the cylinder will be a rock feeding opening 102 which will be cut out to fit the rock hopper 104 which will have a goose neck or elbow shape with a safety flap 106 on top to stop the rocks coming back up. At the bottom of the cylinder will be a series of thin cuts 108 nearly the length of the cylinder and when the rock is broken up enough it will then drop through into a container below. The main bearings used will be the four bolt flange bearing and housing which is the bearings that the shaft goes through.

The walls thickness and size of the cylinder will be changed, the shaft size, bearing size and the impacter bar size will be changed when a smaller or larger version of the gold rock breaker model is built.

Referring again to FIGS. 16 and 17 there is a rock feed 110, a hopper 112, impactor bars 100 (impact bar), end bars 98, bolted end flange 102, welded end flange 114, and duplex pulley 116. The thin cuts 108 are all the way along the bottom of the cylinder. The bolt flange 118 and housing will be the main bearing used. The end bars 98 are flat cross bars welded to the shaft and the impact bars are welded to cross bars rotating at high speed in the round cylinder.

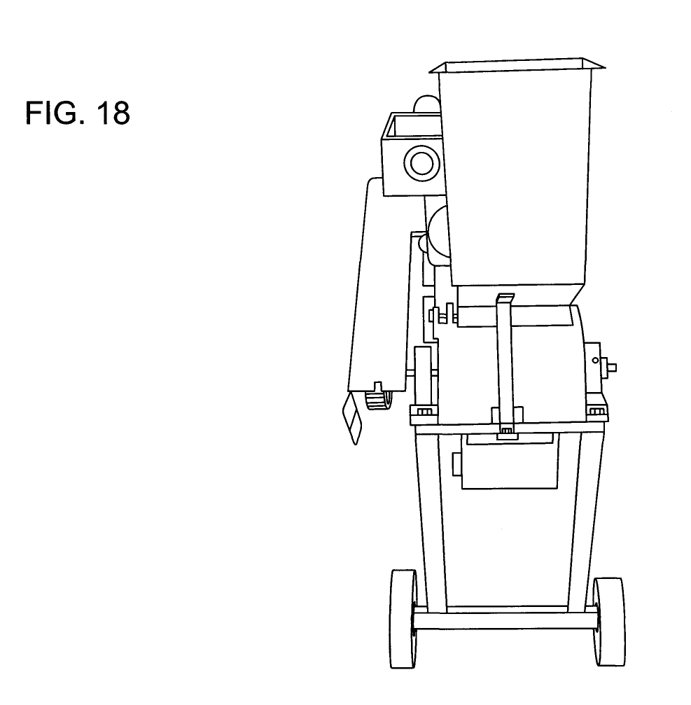

Thus the gold rock breaker cylinder comprises a round steel tube having a shaft which is attached to the bearing and bearing housing at each end. At each end of the steel cylinder are steel flanges each with a hole in the centre for the shaft to go through. On the shaft at each end of the shaft inside the cylinder is a flat steel bar with a hole in each one, so the shaft slides through the middle of these. The flat bar length is nearly the length of the cylinder diameter which gives clearance when rotating and the flat bars are welded to the shaft. Impactor bars are attached to flat bars. On top of the cylinder there are rock feeding opening and rock hopper which will have a goose neck or elbow shape with a safety flap on top to stop the rocks coming back up. The main bearings used will be the four bolt flange bearing and housing which is the bearings that the shaft goes through Various other features are shown in FIGS. 18 to 21.

The rock breakers described provide machines for processing gold bearing rock that are advantageous in that there are a limited number of moving parts within the cylinder chamber. This provides advantageous capacity for crushing of material and relatively no interference from any other parts.

The rock crusher disperses a relatively high quantity of finished material relatively efficiently. Having the impactor spin at high speed is considered to assist with creating a centrifugal force that urges the material towards the sides of the recess.

Having the impactor bars extending along the recess adjacent the slits is considered to assist with cleaning and clearing material from the rock completion slits. This is considered to be advantageous.

As would be apparent, various alterations and equivalent forms may be provided without departing from the spirit and scope of the present invention. This includes modifications within the scope of the appended claims along with all modifications, alternative constructions and equivalents.

There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’ and ‘having’ are to be construed in an inclusive rather than an exclusive sense.

It is to be recognised that any discussion in the present specification is intended to explain the context of the present invention. It is not to be taken as an admission that the material discussed formed part of the prior art base or relevant general knowledge in any particular country or region.

1. A rock breaker comprising: a body having a recess for receiving an impactor that is adapted to rotate about an axis extending longitudinally into the recess; the recess including a curved wall extending along the recess; the curved wall having a number of narrow elongate slit-type openings each extending around the recess across the curved wall; the slit-type openings being spaced apart in a direction along the body to form a series; the impactor including at least one impactor bar that is positioned in an offset position for rotating in a direction along the slit-type openings, in a direction around the recess, with the or each impactor bar extending across the slit-type openings in an adjacent manner.

2. A rock breaker as claimed in claim 1 wherein the recess is a cylindrical recess and the at least one impactor bar comprises two elongate impactor bars spaced apart to fit within the cylindrical recess.

3. A rock breaker as claimed in claim 2 wherein the slit-type openings comprise thin cuts made by cutting and removing material from the body.

4. A rock breaker as claimed in claim 1 wherein the recess is cylindrical and defines a longitudinal axis, the rocker breaker including a hopper having a hopper opening extending through an upper wall of the recess for receiving rock before crushing, wherein the hopper opening is offset from the vertical plane containing the longitudinal axis, the vertical plane being vertical when the rock breaker is in use.

5. A rock breaker as claimed in claim 4 wherein the hopper opening is provided adjacent the vertical plane containing the longitudinal axis.

6. A rock breaker as claimed in claim 5 wherein the hopper opening is provided on one side of the vertical plane containing the longitudinal axis.

7. A rock breaker as claimed in claim 1 wherein the recess includes a hopper having a hopper opening extending through the recess, the opening being positioned such that rotational movement of the at least one impactor bar assists with urging material leaving the hopper in a downward direction by virtue of the impactor moving downwardly in the region below the hopper opening.

8. A rock breaker as claimed in claim 7 wherein the recess is cylindrical and defines the longitudinal axis as the central axis, the curved wall being disposed either side of the vertical plane containing the central axis.

9. A rock breaker as claimed in claim 8 wherein slits are relatively evenly spaced either side of the vertical plane containing the longitudinal axis.

10. A rock breaker as claimed in claim 1 wherein the curved wall having the narrow elongate slit-type openings is provided by a wall member that is moveable between an operational position for rock crushing and an open position allowing ready access to the recess for maintenance purposes.

11. A rock breaker as claimed in claim 10 including a securing system for securing the wall member in the operational position during use of the rock breaker.

12. A rock breaker as claimed in claim 11 wherein the wall member is hingedly connected so as to be able to be pivoted from the operational position to the open position to allow ready access to the recess for maintenance purposes.

13. A rock breaker comprising: a body providing a cylindrical recess for receiving rock; an impactor for rotating about the longitudinal axis of the recess; a plurality of narrow elongate slit-type openings each extending around the recess; the slit type openings being spaced apart in a direction along the body to form a series; the impactor including at least one impactor bar that is positioned in an offset position for rotating in a direction along the slits, in a direction around the recess, with the or each impactor bar extending across the slits in an adjacent manner.
